(19) United States
(12) Patent Application Publication
(10) Pub. No.: US 2025/0222595 A1
(43) Pub. Date: Jul. 10, 2025

(54) FREE-FOCUS IMAGING SYSTEM FOR ROBOTIC AUTOMATION

(71) Applicant: Intrinsic Innovation LLC, Mountain View, CA (US)

(72) Inventor: Kartik Venkataraman, San Jose, CA (US)

(21) Appl. No.: 18/407,713

(22) Filed: Jan. 9, 2024

(51) Int. Cl. B25J 13/08; B25J 9/16; G02B 7/09

(52) U.S. Cl. CPC B25J 13/089; B25J 9/1697; G02B 7/09

(57) ABSTRACT

Methods, systems, and apparatus, including computer programs encoded on a computer storage medium, for enabling a free-focus robotics imaging system. One of the methods includes receiving, in a robotic control system comprising a robot having a plurality of moveable components and a camera comprising a deformable lens mounted on a first component of the one or more movable components of the robot, data from the camera comprising a first working distance from the camera in a workcell. A command is generated to move the one or more movable components. A second working distance is received from the camera as a result of moving the one or more moveable components, and a voltage parameter is applied for the second working distance to the deformable lens to focus the camera at the second working distance.

### BACKGROUND

This specification relates to robotics, and more particularly to controlling robotic movements.

Robotics control refers to scheduling the physical movements of robots in order to perform tasks. These tasks can be highly specialized and in some cases can be directed at a workpiece that the robot can manipulate. For example, an industrial robot that builds cars can be programmed to first pick up a car part and then weld the car part onto the frame of the car. As another example, a robot can pick up components for placement on a printed circuit board. Programming a robot to perform these actions can require planning and scheduling dozens or hundreds of individual movements by robot motors and actuators. In particular, the actions of the robot are accomplished by one or more end effectors mounted at the end, or last link of one or more moveable components, of the robot that are designed to interact with the environment, workpiece, or both.

In some cases, the actions of the robot are monitored and informed by a camera mounted on a moveable component of the robot. In particular, a camera system can be mounted on a moveable component to be used for near-field imaging of objects when the end of arm tooling, e.g., an end effector, gets close to an object of interest, e.g., the workpiece. At close focus distances with respect to the object of interest, the depth of field, e.g., the range of distances between the nearest point in focus to the farthest point in focus for the camera, can be on the order of a few centimeters, which means that the camera is usable for only a very limited portion of the entire working volume of the workcell. In this specification, a workcell is the physical environment in which a robot operates.

Workcells have particular physical properties, e.g., physical dimensions, that impose constraints on how a robot can move as well as what can be perceived by the camera mounted on a moveable component within the workcell. A robot's effectiveness depends on its ability to perceive all parts of the working volume of the workcell. In the case of a camera system mounted on a moveable component of the robot, other cameras can be mounted in or nearby to the workcell to augment the depth of field provided by the camera mounted on the end effector.

A real-time control system uses a real-time controller to dictate what action or movement a robot should take during every period of a control cycle. In this specification, a real-time control system is a software system that is required to perform actions within strict timing requirements in order to achieve normal operation. The timing requirements often specify that certain processes must be executed or certain outputs must be generated within a particular time window in order for the system to avoid entering a fault state. In the fault state, the system can halt execution or take some other action that interrupts normal operation of a robot. With current state of the art systems, refocusing a camera in real-time robotic applications is not practical as it changes the intrinsic parameters of the camera which have been calibrated for a specific application at a specific field of view. Once a camera is refocused, it must be recalibrated before it can be used in the application at a different field of view. Hence, any kind of focus system, e.g., auto or manual, that changes the intrinsic parameters of the camera during operation of a robotic application is not feasible.

### SUMMARY

This specification describes a system implemented as computer programs on one or more computers in one or more locations that can enable free-focus imaging for a camera mounted on a moveable component of a robot. In this specification, free-focus imaging refers to the use of a camera system that can provide clear images over an extended depth of field without having the need to be recalibrated, which would not be possible for a fixed focus lens. In particular, the free-focus robotics imaging system can provide a number of working distance views, e.g., focused images at different working distances with respect to the camera placement in the workcell. At each of these working distances, the intrinsic parameters of the camera remain approximately the same, e.g., barring small residual differences that can be accounted for using a factory calibration procedure, thereby requiring no re-calibrating during operations. In this specification, a working distance view is a view in which an object of interest is in focus for a particular working distance, e.g., the object is in the depth of field of the camera.

The system can provide different working distance views including focused views of the whole volume of the workcell, e.g., including focused views of the workpiece and other objects, using a deformable lens. More specifically, the system can control the shape of the deformable lens using an actuator, e.g., by applying different voltage values to change the shape of the deformable lens. In particular, the system can determine a voltage that maximizes a measure of image sharpness, e.g., based on a measure of the sharpness of edges or features within the image, for each working distance using an autofocus algorithm. The free-focus imaging system can additionally factory calibrate the intrinsic parameters of the camera at different voltage values, e.g., in accordance with different working distance views, in order to increase the accuracy of using the image as a sensor input for downstream tasks, e.g., precision robotics applications.

According to a first aspect there is provided a system for receiving, in a robotic control system comprising a robot having a plurality of moveable components and a camera comprising a deformable lens mounted on a first component of the one or more movable components of the robot, data from the camera comprising a first working distance from the camera in a workcell, generating, by the robotic control system, a command to move the one or more movable components, wherein the command specifies a repositioning of the camera, controlling the robot to move the one or more moveable components according to the command with the robotic control system, receiving a second working distance from the camera as a result of moving the one or more moveable components, obtaining a voltage parameter corresponding to the second working distance, and applying the voltage parameter for the second working distance to the deformable lens to focus the camera at the second working distance.

Particular embodiments of the subject matter described in this specification can be implemented so as to realize one or more of the following advantages.

The free-focus robotics imaging system can replace the need to have multiple cameras operating in the workcell, e.g., at least one mounted at a moveable component and at least one mounted in the workcell. In particular, the free-focus image system can continuously refocus to provide an extended depth of field view over the volume of the workcell without the need for recalibration, thereby enabling the robot to perceive all parts of the working volume with one camera. This decreases the cost of operating the robot, e.g., for an end-of-arm-tooling task, since it is possible to design the robotics vision system to not rely on operating different cameras with different lenses to provide different working distance views. More specifically, the system can enable free-focus imaging for robotic automation using a single optical stack that can provide focused views at all working distances in the workcell for maximal flexibility and efficiency. In particular, the free-focus imaging system can enable the capability to take macroscopic images of an object of interest, e.g., a workpiece or another object of interest, e.g., for tracking, from a short distance away, where the camera can stay in focus as a moveable component of the robot comes very close to the object of interest.

Additionally, the free-focus robotics imaging system is able to control the deformable lens precisely and quickly, e.g., within milliseconds, using the autofocus algorithm to determine one or more voltages to apply to provide a working distance view at a different working distance. In particular, successively applying a voltage to deform the deformable lens for a particular working distance is quicker than the mechanical motion that would be needed to dynamically refocus a camera using a traditional approach, e.g., by using a voice coil motor to reposition one or more lens elements of the optical stack to adjust the focal length mechanically in order to compensate for the change in working distance to the object in focus. The focal length is a measure of how strongly the optical system converges or diverges light and can be changed to refocus light at different working distances by moving the focal plane. The deformable lens of this system allows for the refocusing of the lens without moving the focal plane, thereby enabling the system to refocus to provide different working distance views in real-time.

More specifically, using the deformable lens to change the focus by refracting the light without repositioning the lens elements limits the total change in focal length and other intrinsic parameters over the entire working volume, e.g., over the range of working distances that cover the working volume. Any changes in the intrinsic parameters due to the change in focus caused by the deformable lens are small enough to be accounted for over the entire working volume with a limited number of factory calibration values, e.g., the system can use a factory calibration procedure to determine intrinsic parameters at one or more working distances, e.g., at 100 mm, 500 mm, 2000 mm, in order to provide factory calibration values for partitions of the working volume. This same approach becomes intractable when using a voice coil to refocus the imaging system. Here, the changes to the intrinsic parameters are large and that requires a much larger number of partitions over the working volume for each of which a calibration step is required.

Furthermore, the free-focus robotics imaging system can be used in a real-time robotics control system that generates a command at every tick of a real-time control cycle to adjust the deformable lens for precision robotics applications. Assessing an extended depth of field is especially important in real-time precision robotics applications such as visual servoing systems, e.g., vision-based robotic control systems that use feedback from a camera to control a robot's motion in real-time, and pose estimation systems, e.g., vision-based robotics systems for tracking identified points of an object. Visual servoing and pose estimation systems fail when the objects that are being tracked fall outside the depth of field of a camera. In the case where a camera mounted on a robotic arm is being used to track an object, the motion of the arm can result in the object falling outside the depth of field of the camera from its starting position. Once this happens, the precision robotics application can fail. In particular, adjusting the deformable lens using one or more applied voltages can allow even a robot with hard deterministic time constraints, to dynamically account for the repositioning of the camera in accordance with commands from the real-time robotics control system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example real-time control system that includes a free-focus robotics imaging subsystem that can use a camera with a deformable lens to provide different working distance views.

FIG. 2 illustrates how the free-focus robotics imaging subsystem can be used to determine a voltage that can be applied to a deformable lens to change the working distance view and how the determined voltage can be used to identify the calibrated intrinsic parameters of the camera for downstream applications.

FIG. 3 depicts how different applied voltages can provide different configurations of the deformable lens.

FIG. 4 is a flow diagram of an example process for adjusting the focus of a camera with a deformable lens mounted on a moveable component of a robot in accordance with a movement of the robot.

Like reference numbers and designations in the various drawings indicate like elements.

### DETAILED DESCRIPTION

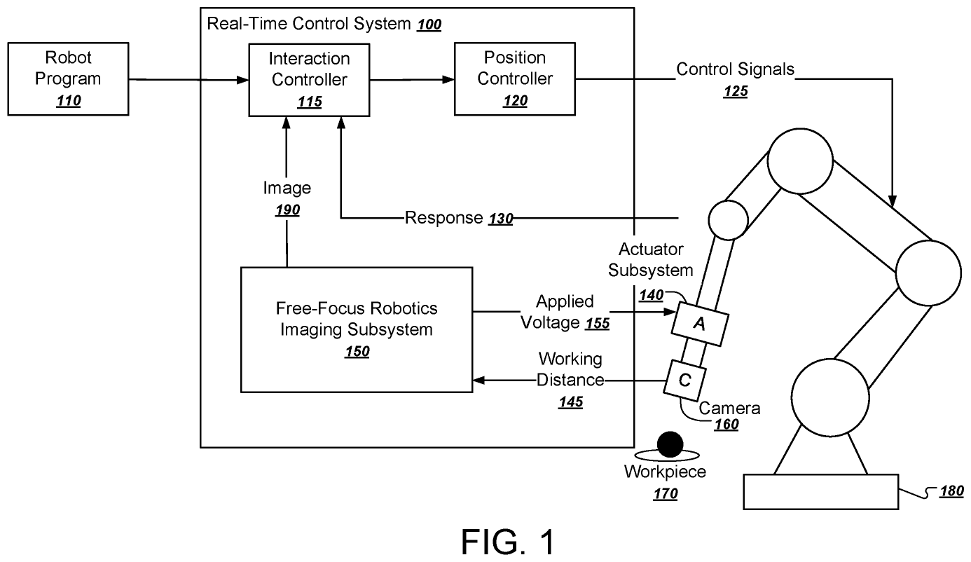

FIG. 1 is a system diagram of an example real-time control system 100 in which a free-focus robotics imaging subsystem controls the working distance view of a camera mounted on a moveable component of a robot. The real-time control system 100 is an example of a system implemented as computer programs on one or more computers in one or more locations in which the systems, components, and techniques described below are implemented.

In particular, the real-time control system 120 can control a robot 180 to perform the actions of a robot program 110. The robot program 110 can be a set of encoded instructions that specify how the robot should perform a particular task, e.g., with respect to an object of interest. In the particular example depicted, the object of interest is a workpiece 170. As an example, the workpiece 170 can be a raw material, a manufactured item, several components of an item that can be put together, etc. When executed by an appropriately programmed real-time or non-real-time computer system, the robot program 110 can provide a goal pose to an interaction controller 115 that can define waypoints specifying the robot's configuration in the next desired pose, e.g., a desired position and orientation for each of the one or more movable components of the robot 180. For example, the next desired pose can be achieved using a position controller 120 that can send control signals 125 as a command to the robot 180 to achieve the next waypoint, e.g., by controlling the robot 180 to move the one or more moveable components according to the command. In some cases, the control signals 125 can direct the robot to interact with the workpiece 170.

In particular, the control signals 125 can be used to control the robot 180, e.g., via low-level controllers, such as low-level joint position controllers or low-level torque controllers to move the one or more moveable components according to the command specified by the control signals 125. The motion of the robot can provide a response 130 back to the interaction controller 115 that can be used to inform the next control cycle, e.g., with respect to achieving the next waypoint. In some cases, e.g., in precision robotics applications such as visual servoing and pose estimation, the robot 180 can use a visual sensor, e.g., a camera 160, to inform the next control signal 125. For example, the camera 160 can provide data that can be used to manipulate the workpiece 170.

In the particular example depicted, the robot 180 has a camera 160 mounted on a moveable component, e.g., a last moveable component, for end-of-arm-tooling to interact with the workpiece 170. In some cases, the camera 160 can be a high-resolution camera. As an example, the end-of-arm-tooling can be a welding torch, mechanical or vacuum gripper, or material removal tool such as a polisher or saw. When the robot moves the one or more movable components, e.g., in accordance with the control signals 125, the camera 160 can be repositioned in the workcell. In particular, the camera 160 can provide important data to the real-time control system 100 regarding the end-of-arm tooling, e.g., using an image 190 from the camera 160. In the particular example depicted, the image 190 is provided by a free-focus robotics imaging subsystem 150 that controls the camera 160, as will be discussed in further-detail below.

The system 100 can control the camera 160 using a free-focus robotics imaging subsystem 150 that processes different working distances 145 to provide different working distance views of the workcell, e.g., using an applied voltage 155 to control a deformable lens in the optical system of the camera 160. In some cases, the control signals 125 can result in a motion for the robot 180 that repositions the camera 160 such that the second working distance of the new configuration is no longer in focus with respect to the first working distance provided by the free-focus robotics imaging subsystem 150 for the previous waypoint. In this case, after the motion that achieves the next waypoint is complete, the free-focus robotics imaging subsystem 150 can receive and process an indication of the second desired working view distance 145 to provide an applied voltage 155 that can achieve the desired working distance view at the new configuration.

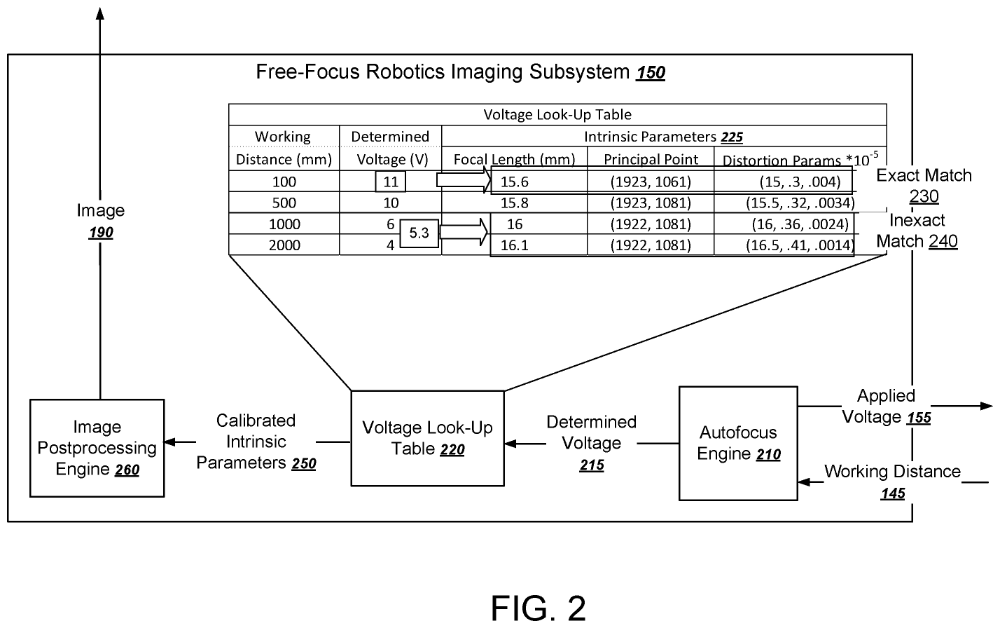

In particular, the applied voltage 155 value can be determined using an autofocus algorithm to determine the voltage that provides a measure of sharpness for the second working distance of the new configuration. In some cases, the autofocus algorithm can specify the application of one or more incremental increasing or decreasing voltages as the applied voltage 155 to increase the sharpness of the view of a region of interest at the first working distance, e.g., a region of interest including the workpiece 170. An example of how the free-focus robotics imaging subsystem 150 can apply an autofocus algorithm to determine the applied voltage 155 corresponding with the second working distance will be described in more detail with respect to FIG. 2.

More specifically, the free-focus robotics imaging subsystem 150 can control the focus of the camera 160 by changing the shape of a deformable lens, e.g., a deformable lens within the optical stack of the camera 160. The optical stack is the optical system of the camera 160, e.g., the optical stack refers to one or more optics components, e.g., an aperture or opening that can intake light and one or more lenses that can focus the light to provide an image, e.g., on a sensor of the camera 160. In some cases, the position of the deformable lens in the optical stack can depend on the placement of the aperture. As an example, the deformable lens can be placed within 100 or between 100 to 200 microns of the aperture of the optical stack, e.g., either in front or behind the aperture. In particular, a proximity within 100 microns to the aperture can enhance the stability of the camera's 160 intrinsic parameters, e.g., focal length, centration, and distortion which characterize the optical system of the camera 160, when the deformable lens changes shape to refocus.

More specifically, in some cases, changing the shape of the deformable lens can introduce small deviations in the intrinsic parameters of the camera that can be corrected for, e.g., by postprocessing the image provided by the camera 160. In this case, the free-focus robotics imaging subsystem 150 can postprocess the image received by the camera before the system 100 uses the image 190 to inform the next control signal 125. In particular, the subsystem 150 can postprocess the image received using a look-up table to identify one or more calibrated intrinsic parameters, e.g., calibrated based on the voltage, for the reconstruction of a three-dimensional (3D) image for a precision robotics application from the two-dimensional (2D) image provided by the camera, as will be discussed in more detail in FIG. 2. In other cases, e.g., robotics applications that do not require such high precision image reconstruction, the free-focus imaging subsystem 150 can employ the image 190 directly without postprocessing, e.g., since the intrinsic parameters of the camera remain stable enough for lower precision applications.

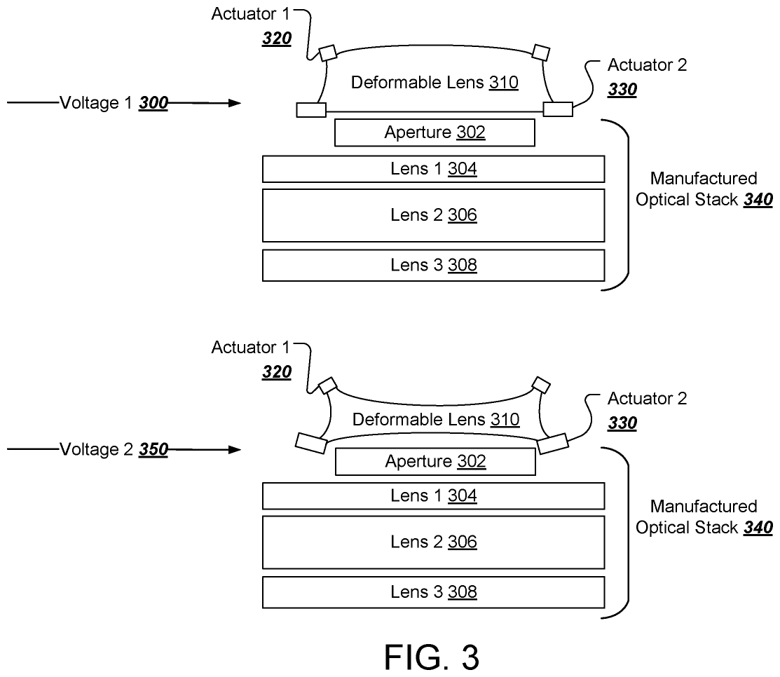

In particular, the subsystem 150 can control the deformable lens using an actuator subsystem 140, e.g., by directing the applied voltage 155 to the actuator subsystem 140 to directly cause a change in the shape of the deformable lens based on the value of the applied voltage 155. The actuator subsystem 140 can include one or more actuators that can deform the shape of the deformable lens. More specifically, the change in the shape of the deformable lens can allow for the refocusing of light to provide a clear image at the second working distance without changing the focal plane of the optical system. In particular, the deformable lens can be a malleable polymer membrane that responds to the application of the applied voltage 155, e.g., changes shape in response to the application of the applied voltage 155. As an example, increasing the value of the voltage can change the deformable lens to provide a working distance view of one or more objects closer to the camera 160, e.g., the workpiece 170, and decreasing the voltage can relax the deformable lens such that incoming light is only bent with the rest of the optical stack at zero voltage. An example of how applying different voltages can change the shape of the deformable lens in different ways is provided in FIG. 3.

In some cases, the deformable lens can be a piezo-electric material, e.g., a piezo-electric polymer membrane. Piezo-electric materials can undergo a reversible process in which an applied electric field causes a change to the dipole moment, e.g., polarization strength or direction, that results in internal mechanical strain that deforms the material. Conversely, a mechanical strain to the piezo-electric material, e.g., by bending or compressing the material, can result in a change to the dipole moment that generates a voltage. In this case, the actuator subsystem 140 can control the shape of the deformable lens using the applied voltage 155, e.g., by causing a change to the dipole moment of the material by applying a current or causing mechanical strain to the piezo-electric material. In some cases, the response time of the piezo-electric membrane can be about 1 to 5 ms, e.g., from the time when the calibrated voltage 155 is applied to the time when the deformable lens has reached the intended shape, e.g., as is specified by an autofocus algorithm. In particular, the use of a piezo-electric lens as the deformable lens can enable faster cycle times with respect to refocusing the camera 160 in real-time control systems, e.g., the real-time control system 100.

The deformable lens of the camera 160 can be refocused to provide a clear image at a variety of working distances, thereby increasing the usability of the camera 160 over the entire volume of the workcell. In particular, the free-focus robotics imaging subsystem 150 can deform the shape of the deformable lens, e.g., using the actuator 140 subsystem, to change the depth of field provided by the camera 160 without changing the focal length of the camera 160. This eliminates the requirement to include additional cameras in the workcell of the robot 180, e.g., different cameras to provide different working distance views, and precludes the need for mechanical refocusing of the camera 160, e.g., by changing the focal length of the optical system using a voice coil motor, which is too slow for real-time robotics control systems operating at every tick of a real-time control cycle, e.g., the real-time robotics control system 100.

FIG. 2 depicts an example free-focus robotics imaging subsystem and demonstrates how the subsystem can determine and apply a voltage to a deformable lens, e.g., the deformable lens of camera 160 of FIG. 1, to change the working distance view. FIG. 2 additionally illustrates how the subsystem can be used to identify calibrated intrinsic parameters for postprocessing of the image provided by the camera.

In particular, the free-focus robotics imaging subsystem 150 can receive a desired working distance, e.g., the working distance 145 for the camera mounted on a moveable component of the robot 180, and identify a voltage value to apply, e.g., the applied voltage 155, using an autofocus algorithm. More specifically, the subsystem 150 can process the view of the working distance 145 using an autofocus engine 210 that implements the autofocus algorithm to determine an applied voltage 155 that can increase the sharpness of the image provided by the camera at the working distance 145. As an example, the autofocus engine 210 can calculate a sequence of gradients between each pixel and the surrounding pixels in the image of the working distance 145. More specifically, the engine 210 can assess the image sharpness of the view at the working distance 145 using pixel brightness to provide a notion for how the sharpness changes in each direction from a given pixel. In some cases, the autofocus engine 210 can assess the sharpness over the whole image provided by the camera. In other cases, the autofocus engine 210, can assess the sharpness for a region of interest, e.g., the region of the image that includes the workpiece or another object of interest.

In particular, the autofocus engine 210 can calculate sequence of gradients via a Laplacian operator, e.g., a second-order differential operator to measure local spatial variations in an image I(x,y) received at the working distance 145 with x and y dimensions: ∇²I(x, y)=∂²I/∂x²+∂²I/∂y². In other cases, the engine 210 can approximate the Laplacian operator using a finite difference calculation: ∇²I(i, j)=I(i+1, j)+I(i−1, j)+I(i, j+1)+I(i, j−1)−4I(i, j) where i and j are indices that can be used to traverse the x and y dimension of the image I(x, y) and a boundary condition can be defined for border pixels. In the case in which the autofocus engine 210 assesses the sharpness over a region of interest, the i and j indices can be restricted between values of the region of interest. In particular, the finite difference sequence of gradients can be computed for each pixel independently and is easily parallelizable. More specifically, the engine 210 can calculate the sequence of gradients over all pixels and take the mean of the values over the whole region or a region of interest, e.g., a region that includes the workpiece.

The autofocus engine 210 can determine the determined voltage 215 that provides the best focus, e.g., the sharpest image for the current working distance, using a hill climbing procedure, e.g., simple hill climbing, steepest-ascent hill climbing, stochastic hill climbing, to iteratively find a better solution by changing the voltage, e.g., using the applied voltage 155, and assessing the sharpness according to the sequence of gradients for the image. In particular, the autofocus engine 210 can successively apply one or more voltages, e.g., using the applied voltage 155, and reassess the sharpness of the image at the working distance 145 until a measure of maximum image sharpness is achieved. In some cases, the maximum sharpness can be defined as the voltage at which the magnitude of the image's Laplacian is maximized.

In the particular example depicted, after the autofocus engine 210 determines a determined voltage 215 for the working distance 145, e.g., through the application of one or more applied voltages 155, the free-focus robotics imaging subsystem 150 can use the determined voltage 215 to identify the calibrated intrinsic parameters 250 of the optical stack of the camera at the working distance 145. More specifically, the subsystem 150 can use a voltage look-up table 220 that includes factory calibrated intrinsic parameters 225 at a number of voltage values to assess any deviation of the intrinsic parameters of the camera at the determined voltage 215, e.g., as compared to the intrinsic parameters of the optical system with no voltage applied. The identified residual differences can then be used for downstream applications, e.g., postprocessing of the 2D image provided by the camera into a 3D image that can be employed for precision robotics applications, e.g., visual servoing or pose estimation.

As an example, the intrinsic parameters 225 of the voltage look-up table 220 can include one or more optical parameters that characterize the depth of field of the optical system of the camera, e.g., the range of distances between the nearest point in focus to the farthest point in focus for the camera. In the particular example depicted, the intrinsic parameters 225 can include the focal length, e.g., the distance between the camera's lens and the image sensor, the principal point, e.g., pixel coordinates that define the placement where the optical axis intersects the image sensor for a horizontal and vertical axis, and a set of one or more distortion parameters to calibrate for any small differences at a number of voltages for the camera. As an example, the distortion parameters can provide a set of one or more distortion values depending on which distortion model was used during calibration, e.g., the set of distortion parameters can include radial and tangential lens distortion coefficients that account for inherent distortions introduced by the camera's lens. As another example, the intrinsic parameters can include a centration, e.g., a measurement of the beam deviation between the mechanical axis defined by the maximum lens diameter and optical axis as defined by the optical surface of the lens, F number, e.g., the ratio of the optical system's focal length to the aperture, and pixel pitch, e.g., pixel size. The intrinsic parameters 225 for a number of working distances can be determined using a factory calibration procedure, as will be described in more detail below, and indexed by voltage stored in a voltage look-up table 220, e.g., indexed by voltage.

In some cases, when taken together, the intrinsic parameters 225 can define a hyperfocal distance of the optical system of the camera: the distance at which, if the camera is focused, the range of acceptable focus, e.g., the range of distances between the nearest point in focus to the farthest point in focus for the camera, is from half the hyperfocal distance to infinity. The hyperfocal distance can be defined by the F number, focal length, and pixel size and represents the maximum depth of field for the imaging system, e.g., the camera 160 of FIG. 1. If the focus distance of the camera is kept closer than the optical system's hyperfocal distance, the depth of field is correspondingly smaller. The free-focus robotics imaging subsystem 150 can adjust the plane of focus and depth of field of the imaging system to focus at different distances by identifying the determined voltage 155 that provides a clear image at the desired working distance 145.

In particular, the free-focus robotics imaging subsystem 150 can employ the determined voltage 215 to identify small residual differences in the intrinsic parameters 225 of the optical system at the determined voltage 215 using the voltage look-up table 220. In the particular example depicted, the voltage look-up table 220 can provide the intrinsic parameters 225 to calibrate for small residual differences at a number of voltages for a camera with a 16 mm lens, e.g., a 16 mm focal length lens. In particular, the system 150 can pre-calibrate the intrinsic parameters 225 voltage look-up table 220 at a limited number of values, e.g., 5, 12, 25, to cover the range of working distances of the workcell since the intrinsic parameters are relatively stable due to the deformable lens. More specifically, the voltage look-up table 220 can be indexed based on the determined voltage 215 to provide calibrated intrinsic parameters 250 that can be used for image postprocessing, e.g., by an image postprocessing engine 260. As an example, the image postprocessing engine 260 can construct a 3D image using the 2D image provided by the camera by taking the updated calibrated intrinsic parameters 250 into account.

In the case that there is an exact match with the index of the voltage look-up table 220, the subsystem 150 can return the intrinsic parameters 225, e.g., the focal length, principal point, and distortion parameters, from the voltage index value of the exact match row from the table 220. As an example, in the case of the autofocus engine 210 providing the determined voltage 215 of 11 V, resulting in the exact match 230, the subsystem 150 can return a focal length of 15.6 mm, principal point of (1923, 1061), and distortion parameters of (15, 0.3, 0.004)*10\hat{ }−5 as the calibrated intrinsic parameters 250.

In the case that there is not an exact match, the voltage indices of the voltage look-up table 220 can be used to estimate the appropriate calibrated intrinsic parameters 250, e.g., using interpolation of the intrinsic parameters 225 between the known values of the voltage indices in the table 220. As an example, in the case of the autofocus engine 210 providing the determined voltage 215 value of 5.3 V, resulting in the inexact match 240, the subsystem can interpolate between the intrinsic parameters 225 provided by the voltage indices of the available index voltages in the voltage look-up table 220. In some cases, the subsystem 150 can provide the calibrated intrinsic parameters 250 of the nearest available determined voltage value 215. In other cases, the subsystem 150 can estimate the calibrated intrinsic parameters 250 by fitting a model, e.g., a logistic regression model, spline, or k-nearest neighbors model using the data included in the voltage look-up table 220. As another example, the free-focus robotics imaging subsystem 150 can provide calibrated intrinsic parameters 250 by combining the intrinsic parameters 225 from voltages that bookend, e.g., the voltage indices immediately above and below the determined voltage 215 in the table 220.

In particular, the subsystem 150 can combine the intrinsic parameters 225 by taking an average of the intrinsic parameters 225 of the voltage indices that are above but nearest to and below but nearest to the determined voltage 215. For example, the subsystem 150 can calculate an estimation of the calibrated intrinsic parameters 250 by applying a weighted average formula to each of the intrinsic parameters of the optical system to determine the weights for each index for each parameter, and then averaging the determined parameters for each respective voltage index. In this case, the calibrated intrinsic parameters 250 can be provided as a decimal number up to a predetermined number of significant figures or can be rounded, e.g., to the nearest one, tenth, hundredth, or thousandth of a volt. More specifically, in the case of the inexact match 240, the subsystem 150 can calculate the weights for the voltage immediately below and voltage immediately above, which can then be applied to the intrinsic parameters stored in the voltage look-up table 220. In particular, a system of equations can be solved that includes a(voltage below)+b(voltage above)=determined voltage 215 to provide the weights a and b for the intrinsic parameters provided by the voltage immediately below and voltage immediately above. In some cases, the values of a and b can be set to a simple average of the intrinsic parameters, e.g., ½*(16+16.1) for the focal length, ½*(1922+1922, 1081+1081) for the principal point values, and ½*(16+16.5, 0.36+0.41, 0.0024+0.0014) to provide values of 16.05 mm, (1922, 1081), and (16.25, 0.385, 0.0019).

The calibrated intrinsic parameters 250 determined from the voltage look-up table 220 can then be used to process the image at the working distance 145 using an image postprocessing engine 260. As an example, the image postprocessing engine 260 can reconstruct a 3D image of the region of interest using the calibrated intrinsic parameters 250, e.g., by performing a change of coordinates informed by the calibrated intrinsic parameters 250. In particular, the 3D reconstruction can enable accurate and precise 3D measurements to be inferred from the image captured by the camera that can be used for pose processing, e.g., the engine 260 can provide the postprocessed image 190 to the interaction controller 115 to plan the next waypoint. More specifically, the image 190 can enable downstream applications that require high precision, such as visual servoing, e.g., for bin picking, and pose estimation.

The free-focus robotics imaging subsystem 150 can determine the values of the voltage look-up table 220 by factory calibrating one or more intrinsic optical parameters, e.g., the intrinsic parameters 225, across a range of working distances that cover the full depth of field necessary for the camera's operation. In particular, the subsystem 150 can identify one or more working distances, e.g., from 10 cm to 3 m in linearly increasing steps. At each identified working distance, the subsystem 150 can either apply an increasing or decreasing voltage to the deformable lens to change the focus in a desired direction and then re-evaluate the sharpness of the image. In some cases, the subsystem 150 can repeat the process at each identified working distance a number of times to ensure precision of the determined calibration values.

For example, the subsystem 150 can factory calibrate the intrinsic parameters of the camera by capturing images of a ChArUco board at different distances to cover the depth of field necessary for the camera to operate at an acceptable focus over the whole volume or a portion of the volume of the work cell. A ChArUco board is a combination of a chessboard and a binary identifier board (ArUco) board that serves as a standard for corner detection and calibration of computer vision systems. In particular, using a ChArUco board provides flat targets with perfect square length for image calibration. The subsystem 150 can use the extracted corners of the ChArUco board in each image along with the known dimensions of the squares in the board to create a two- or three-dimensional correspondence to estimate the camera's pose, e.g., using Zhang's method to estimate the intrinsic parameters of the camera as described with reference to Zhang, Zhengyou: “A flexible new technique for camera calibration.” IEEE Transactions on pattern analysis and machine intelligence 22.11 (2000): 1330-1334. More specifically, the subsystem 150 can compare the ChArUco board points directly with the camera images, e.g., using the root mean square average difference in pixels between the detected and estimated pixel coordinates of the ChArUco board, to identify the intrinsic parameters of the optical system at the different working distances.

FIG. 3 depicts an example optical system of a camera and demonstrates how different voltages, e.g., different applied voltage values provided by the free-focus robotics imaging subsystem 150 of FIGS. 1 and 2, can provide different configurations of the deformable lens using one or more actuators that control the shape of the deformable lens.

In the particular example depicted, the optical system is an optical stack that includes an aperture 302 to intake light, a deformable lens 310, lens 1 304, lens 2 306, and lens 3 308. As an example, the optical stack can be included in the camera, e.g., the camera 160 of FIG. 1, on a movable component of the robot. The optical stack functions to focus the light to a sensor in order to provide the image. For most robotic applications, the optical system functions to converge light, e.g., the focal length is positive. A positive focal length can be achieved by the lenses 304, 306, and 308, e.g., when the deformable lens is totally relaxed and not bending light. In particular, the lenses 304, 306, and 308 can be convex lenses, concave lenses, or both convex and concave lenses.

In the case in which the deformable lens 310 is within 100 microns of the aperture, e.g., to enhance the stability of the intrinsic parameters, the deformable lens 310 can be the first element in the optical stack, e.g., the deformable lens 310 can refract light before the light enters the aperture 302. Additionally, in this case, the deformable lens 310 can be included in a standard manufactured optical stack, e.g., the free-focus robotics imaging subsystem 150 does not require a specialized optical stack to operate and can enable free-focusing for a standard optical stack by including the deformable lens 310 as a component. In the particular example depicted, the aperture 302 and the lenses 304, 306, and 308 are part of the standard manufactured optical stack 340.

The deformable lens 310 can allow for continuous use of the camera over a range of working distances. More specifically, the intrinsic parameters of the optical system including the deformable lens, e.g., the focal length, field of view, and centration, can change reversibly based on the application and removal of the application of the voltage. By focusing the optical stack for different working distances using the deformable lens 210, differently sized fields of view can be obtained at a constant viewing angle using the same optical stack.

In the particular example depicted, the different voltages, e.g., voltage 1 300 and voltage 2 350, can be applied to one or more actuators as part of an actuator subsystem, e.g., the actuator subsystem 140 of FIG. 1. In this case, the actuator subsystem has two actuators: actuator 1 320 and actuator 2 330 that can apply a current based on the voltages 300 and 350 to deform the deformable lens 310. In some cases, the deformable lens 310 is a piezo-electric membrane. The voltage applied can be determined using an autofocus algorithm, e.g., using the autofocus algorithm discussed in FIG. 2, and provided to the actuators 320 and 330. As an example, voltage 1 300 and voltage 2 350 can be provided in response to the robot moving in a way that repositions the camera and necessitates providing a different working distance view.

In the example with voltage 1 300, the movement of actuators 1 320 and actuators 330 cause the deformable lens 310 to become more convex, e.g., the light coming in through the aperture 302 becomes more focused with the shape of the deformable lens 310 than when the deformable lens 310 is relaxed. In the example with voltage 2 350, the movement of actuators 1 320 and actuators 330 cause the deformable lens 310 to become more concave, e.g., the light coming in through the aperture 302 is more dispersed with the shape of the deformable lens 310 than when the deformable lens 310 is relaxed.

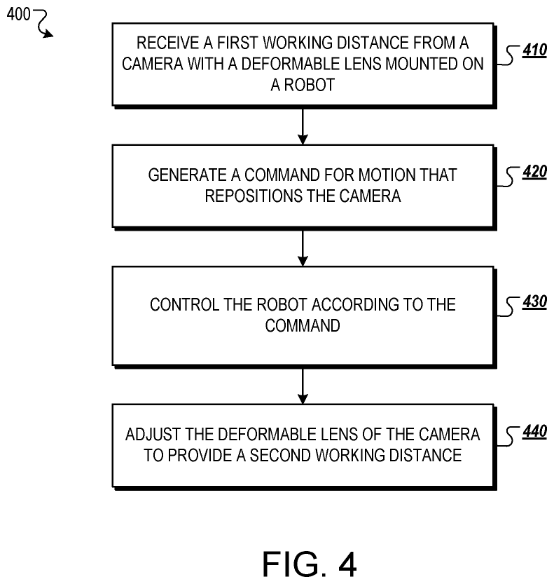

FIG. 4 is a flow diagram of an example process for adjusting a deformable lens of a free-focus robotics imaging system in accordance with a movement of the robot that repositions the camera. For convenience, the process 400 will be described as being performed by a system of one or more computers located in one or more locations. For example, a free-focus robotics imaging subsystem, e.g., the free-focus robotics imaging subsystem 150 included in the real-time control system 100 of FIG. 1, appropriately programmed in accordance with this specification, can perform the process 400.

In particular, the system can first receive a first working distance from a camera mounted on a robot (step 410). As an example, the camera can be mounted on a moveable component of the robot, e.g., the last moveable component or end-effector. In particular, the camera can have an optical system that includes a deformable lens. The system can control the range of distances in focus by changing the shape of the deformable lens, e.g., by applying a voltage to an actuator subsystem that includes one or more actuators. In some cases, the deformable lens is a piezo-electric material.

The system can generate a command for a motion of the robot (step 420) and control the robot according to the command (step 430). In some cases, the command for the motion of the robot can reposition the camera, e.g., for an end-of-arm-tooling task. In this case, the repositioning of the camera can result in a loss of sharpness of the image provided by the camera since the camera is focused to provide a working distance view at a first working distance.

The system can then adjust the deformable lens of the camera to provide a second working distance, e.g., to account for the repositioning of the camera (step 440). More specifically, the system can adjust the deformable lens by applying a voltage value to change the shape of the deformable lens, e.g., in a direction corresponding to increasing sharpness of the image. In some cases, the measure of sharpness of the image can be determined based on the Laplacian of the image. In particular, the system can obtain a voltage value by employing an autofocus algorithm that successively applies a voltage to provide an increasingly clear image at the second working distance and identify a determined voltage value at which the image sharpness is maximized.

In some cases, the system can additionally post-process the image provided by the camera at the second working distance view using a voltage look-up table. As an example, the system can identify the intrinsic parameters of the optical system at the determined voltage for use in postprocessing, e.g., such that the image can be reconstructed in 3D for visual servoing or pose estimation applications. The intrinsic parameters can include one or more of a focal length, principal point, and one or more of radial and tangential lens distortion coefficients. The system can use the obtained voltage value to deform the deformable lens in order to provide the second working distance view, e.g., using the actuator subsystem.

In some cases, the second working distance view is of a narrower depth of field than the first working distance view. In other cases, the second working distance view is of a wider depth of field than the first working distance view. In particular, the system can use the deformable lens to enable the system to continuously refocus the deformable lens to provide an extended depth of field over a range of working distances that encompasses the entire volume of the workcell without need for recalibration.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving, in a robotic control system comprising a robot having a plurality of moveable components and a camera comprising a deformable lens mounted on a first component of the one or more movable components, data from the camera comprising a first working distance from the camera in a workcell;
   generating, by the robotic control system, a command to move the one or more movable components, wherein the command specifies a repositioning of the camera;
   controlling the robot to move the one or more moveable components according to the command with the robotic control system;
   receiving a second working distance from the camera as a result of moving the one or more moveable components;
   obtaining a voltage parameter corresponding to the second working distance; and
   applying the voltage parameter for the second working distance to the deformable lens to focus the camera at the second working distance.

Embodiment 2 is the method of embodiment 1, wherein the first working distance comprises the workcell and the second working distance comprises a workpiece in the workcell.

Embodiment 3 is the method of any one of embodiments 1-2, further comprising adjusting the deformable lens to continuously refocus the camera in a free-focus imaging system to provide an extended depth of field comprising a plurality of working distances of the workcell and the workpiece.

Embodiment 4 is the method of any one of embodiments 1-3, wherein the camera further comprises an optical system comprising an aperture and one or more lens elements placed in an order of lens elements.

Embodiment 5 is the method of any one of embodiments 1-4, wherein the deformable lens is placed within 100 microns from the aperture.

Embodiment 6 is the method of any one of embodiments 1-5, wherein the deformable lens is placed as the first lens element in the order of lens elements.

Embodiment 7 is the method of any one of embodiments 1-6, wherein the free-focus imaging system further comprises a fixed-aperture system.

Embodiment 8 is the method of any one of embodiments 1-7, wherein the deformable lens comprises a piezo-electric polymer and an actuator configured to control the shape of the piezo-electric polymer by applying a voltage to change the focus of the deformable lens.

Embodiment 9 is the method of any one of embodiments 1-8, wherein applying the voltage further comprises identifying a voltage value to change the focus of the deformable lens in accordance with providing the second working distance.

Embodiment 10 is the method of any one of embodiments 1-9, wherein identifying a voltage value comprises applying an autofocus algorithm further comprising:
receiving an image from the camera comprising a plurality of pixels, each indicative of a brightness;
   for each pixel, evaluating a sequence of one or more gradients to characterize a sharpness of the image; and
   determining a maximizing voltage at which the sharpness is maximized over one or more regions of interest in the image at the working distance.

Embodiment 11 is the method of any one of embodiments 1-10, further comprising using a hill climbing procedure to determine the maximizing voltage.

Embodiment 12 is the method of any one of embodiments 1-11, further comprising using a look-up table indexed by a plurality of voltage values to identify one or more intrinsic parameters of the optical system in accordance with providing the second working distance.

Embodiment 13 is the method of any one of embodiments 1-12, wherein, for each index voltage value in the look-up table, the one or more intrinsic parameters of the optical system comprise a focal length, principal point, and set of one or more lens distortion coefficients.

Embodiment 14 is the method of any one of embodiments 1-13, further comprising interpolating between the intrinsic parameters of the optical system at a first index voltage value and the intrinsic parameters of the optical system at a second index voltage value to determine the one or more intrinsic parameters in accordance with providing the second working distance at an intermediate voltage value.

Embodiment 15 is the method of any one of embodiments 1-14, wherein the intrinsic parameters of the optical system at each index voltage value of the look-up table have been determined from calibrating the one or more optical parameters of the optical system across a range of one or more working distances.

Embodiment 16 is the method of any one of embodiments 1-15, wherein calibrating the one or more optical parameters of the optical system at each index voltage value further comprises, for the range of one or more working distances:
using the autofocus algorithm to determine the maximizing voltage at a working distance in the range; and
applying Zhang's method to determine the optical parameters of the optical system.

Embodiment 17 is the method of any one of embodiments 1-16, wherein the robotic control system is a real-time robotic control system that generates a command at every tick of a real-time control cycle, and further comprising adjusting the deformable lens at every tick of the real-time control cycle.

Embodiment 18 is a system comprising: one or more computers and one or more storage devices storing instructions that are operable, when executed by the one or more computers, to cause the one or more computers to perform the method of any one of embodiments 1 to 17.

Embodiment 19 is a computer storage medium encoded with a computer program, the program comprising instructions that are operable, when executed by data processing apparatus, to cause the data processing apparatus to perform the method of any one of embodiments 1 to 17.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving, in a robotic control system comprising a robot having a plurality of moveable components and a camera comprising a deformable lens mounted on a first component of the one or more movable components, data from the camera comprising a first working distance from the camera in a workcell;
generating, by the robotic control system, a command to move the one or more movable components, wherein the command specifies a repositioning of the camera;
controlling the robot to move the one or more moveable components according to the command with the robotic control system;
receiving a second working distance from the camera as a result of moving the one or more moveable components;
obtaining a voltage parameter corresponding to the second working distance; and
applying the voltage parameter for the second working distance to the deformable lens to focus the camera at the second working distance.

2. The method of claim 1, wherein the first working distance comprises the workcell and the second working distance comprises a workpiece in the workcell.

3. The method of claim 2, further comprising adjusting the deformable lens to continuously refocus the camera in a free-focus imaging system to provide an extended depth of field comprising a plurality of working distances of the workcell and the workpiece.

4. The method of claim 3, wherein the camera further comprises an optical system comprising an aperture and one or more lens elements placed in an order of lens elements.

5. The method of claim 4, wherein the deformable lens is placed within 100 microns from the aperture.

6. The method of claim 5, wherein the deformable lens is placed as the first lens element in the order of lens elements.

7. The method of claim 6, wherein the free-focus imaging system further comprises a fixed-aperture system.

8. The method of claim 7, wherein the deformable lens comprises a piezo-electric polymer and an actuator configured to control the shape of the piezo-electric polymer by applying a voltage to change the focus of the deformable lens.

9. The method of claim 8, wherein applying the voltage further comprises identifying a voltage value to change the focus of the deformable lens in accordance with providing the second working distance.

10. The method of claim 9, wherein identifying a voltage value comprises applying an autofocus algorithm further comprising:
receiving an image from the camera comprising a plurality of pixels, each indicative of a brightness;
for each pixel, evaluating a sequence of one or more gradients to characterize a sharpness of the image; and
determining a maximizing voltage at which the sharpness is maximized over one or more regions of interest in the image at the working distance.

11. The method of claim 10, further comprising using a hill climbing procedure to determine the maximizing voltage.

12. The method of claim 11, further comprising using a look-up table indexed by a plurality of voltage values to identify one or more intrinsic parameters of the optical system in accordance with providing the second working distance.

13. The method of claim 12, wherein, for each index voltage value in the look-up table, the one or more intrinsic parameters of the optical system comprise a focal length, principal point, and set of one or more lens distortion coefficients.

14. The method of claim 13, further comprising interpolating between the intrinsic parameters of the optical system at a first index voltage value and the intrinsic parameters of the optical system at a second index voltage value to determine the one or more intrinsic parameters in accordance with providing the second working distance at an intermediate voltage value.

15. The method of claim 14, wherein the intrinsic parameters of the optical system at each index voltage value of the look-up table have been determined from calibrating the one or more optical parameters of the optical system across a range of one or more working distances.

16. The method of claim 15, wherein calibrating the one or more optical parameters of the optical system at each index voltage value further comprises, for the range of one or more working distances:
using the autofocus algorithm to determine the maximizing voltage at a working distance in the range; and
applying Zhang's method to determine the optical parameters of the optical system.

17. The method of claim 16, wherein the robotic control system is a real-time robotic control system that generates a command at every tick of a real-time control cycle, and further comprising adjusting the deformable lens at every tick of the real-time control cycle.

18. A system comprising one or more computers and one or more storage devices storing instructions that are operable, when executed by the one or more computers to cause the one or more computers to perform operations comprising:
receiving, in a robotic control system comprising a robot having a plurality of moveable components and a camera comprising a deformable lens mounted on a first component of the one or more movable components, data from the camera comprising a first working distance from the camera in a workcell;
generating, by the robotic control system, a command to move the one or more movable components, wherein the command specifies a repositioning of the camera;
controlling the robot to move the one or more moveable components according to the command with the robotic control system;
receiving a second working distance from the camera as a result of moving the one or more moveable components;
obtaining a voltage parameter corresponding to the second working distance; and
applying the voltage parameter for the second working distance to the deformable lens to focus the camera at the second working distance.

19. The system of claim 18, wherein the first working distance comprises the workcell and the second working distance comprises a workpiece in the workcell.

20. A computer storage medium encoded with a computer program, the program comprising instructions that are operable, when executed by data processing apparatus to cause the data processing apparatus to perform operations comprising:
receiving, in a robotic control system comprising a robot having a plurality of moveable components and a camera comprising a deformable lens mounted on a first component of the one or more movable components, data from the camera comprising a first working distance from the camera in a workcell;
generating, by the robotic control system, a command to move the one or more movable components, wherein the command specifies a repositioning of the camera;
controlling the robot to move the one or more moveable components according to the command with the robotic control system;
receiving a second working distance from the camera as a result of moving the one or more moveable components;
obtaining a voltage parameter corresponding to the second working distance; and
applying the voltage parameter for the second working distance to the deformable lens to focus the camera at the second working distance.
